(19) United States
(12) Patent Application Publication
(10) Pub. No.: US 2026/0291804 A1
(43) Pub. Date: Sep. 24, 2026

(54) Battery Manufacturing System and Alarm Handling Method Thereof

(71) Applicant: SK On Co., Ltd., Seoul (KR)

(72) Inventor: Jae Hoon JUNG, Daejeon (KR)

(21) Appl. No.: 19/570,389

(22) Filed: Mar. 18, 2026

(30) Foreign Application Priority Data
Mar. 20, 2025 (KR) 10-2025-0035976

(51) Int. Cl. H04L 41/0604; H04L 41/0659; H04L 41/0686

(52) U.S. Cl. CPC H04L 41/0609; H04L 41/0627; H04L 41/0661; H04L 41/0686

(57) ABSTRACT

The present disclosure relates to a battery manufacturing system. The battery manufacturing system according to an embodiment of this disclosure may comprise: a first server unit storing a possible alarm information that may be occurred and received from a battery manufacturing device; a second server unit generating an analysis information based on the possible alarm information; a third server unit classifying the importance of alarm generated by the battery manufacturing device into grades using the analysis information; and a fourth server unit receiving the classified grade of the occurred alarm and corresponding response method from the third server unit and notifying a user thereof.

### CROSS-REFERENCE TO RELATED PATENT APPLICATION

The present application claims priority under 35 U.S.C. § 119a to Korean patent applications number 10-2025-0035976 filed on Mar. 20, 2025 in the Ministry of Intellectual Property in Korea, the entire disclosures of which are incorporated by reference herein.

### BACKGROUND OF THE DISCLOSURE

### 1. Field

This disclosure relates to a battery manufacturing system and an alarm handling method thereof.

### 2. Description of the Related Art

Battery manufacturing equipment may be composed of various hardware components. Alarms indicating abnormal conditions of the hardware constituting the battery manufacturing equipment may be diverse.

The battery manufacturing industry has mass production characteristics, making alarm handling even more critical. Particularly, relying on the subjective judgment of user limits improvements in yield and equipment utilization rates. Therefore, a technical approach to alarm management is necessary. A system that enables real-time tracking and prioritization of alarms through automated monitoring and analysis, analyzes root causes, and takes preventive measures is crucial. Such a system minimizes operator intervention and maximizes manufacturing efficiency through data-driven decision-making.

First, according to one aspect of the present disclosure, an object is to classify alarms by importance grade and provide users with optimized action methods for each grade.

Second, according to another aspect of the present disclosure, an object is to enable prompt action by predicting intermediate alarms in advance and notifying the user. For intermediate alarms, preemptive prediction prevents actual failures. Regarding responses, by utilizing historical failure response data, maintenance personnel can prepare responses in advance without needing to directly verify the equipment failure status. This allows for advance preparation of tasks, significantly reducing response time.

Third, according to another aspect of the present disclosure, an object is to minimize delays in battery manufacturing system operation caused by false alarms by reducing their occurrence ratio.

Meanwhile, this invention may be widely applied in the fields of electric vehicles, battery charging stations, energy storage systems, and other green technologies utilizing batteries, such as photovoltaics and wind power.

Furthermore, this invention may be used in eco-friendly mobility, including electric vehicles and hybrid vehicles, to prevent climate change by suppressing air pollution and greenhouse gas emissions.

### SUMMARY OF THE DISCLOSURE

A battery manufacturing system according to an embodiment of this disclosure may comprise: a first server unit configured to store a possible alarm information received from a battery manufacturing device; a second server unit configured to generate an analysis information based on the possible alarm information; a third server unit configured to classify alarms by importance level using the analysis information; and a fourth server unit configured to receive the alarm's classified importance level and a corresponding response method from the third server unit and to notify a user thereof.

In an embodiment, the second server unit may transmit the analysis information to the third server unit in response to a signal in API (Application Programming Interface) format.

In an embodiment, the second server unit may include an analysis unit generating the analysis information based on the possible alarm information and a communication interface transmitting the analysis information to the third server unit in response to a signal in API format.

In an embodiment, the third server unit may classify an occurred alarm into a false alarm and an intermediate alarm.

In an embodiment, the third server unit may classify the occurred alarm as one of a false alarm, an intermediate alarm, or a minor alarm.

In an embodiment, the analysis information may include criteria for classifying the alarm's importance level.

In an embodiment, the third server unit may include: a false alarm reset engine determining whether the occurred alarm corresponds to the false alarm and automatically resetting the battery manufacturing device when alarm is confirmed as a false alarm; and an alarm analysis engine that classifies alarms by importance level using the analysis information.

In an embodiment, the alarm analysis engine may transmit an alarm prediction notification to the fourth server unit when an intermediate alarm is predicted.

In an embodiment, the alarm analysis engine may update the battery manufacturing device to reduce the ratio of the alarms classified as false alarms among the false alarms, the minor alarms, and the intermediate alarms.

In an embodiment, the alarm analysis engine may transmit the alarm's classified importance level and a corresponding response method to the fourth server unit.

In an embodiment, the false alarm reset engine may be connected to the battery manufacturing device and receives alarms that occur from the battery manufacturing device.

In an embodiment, the third server unit may further include an alarm log unit receiving the occurred alarm from the false alarm reset engine and transmitting it to the alarm analysis engine.

An alarm handling method of a battery manufacturing system, including a first server unit, a second server unit, a third server unit, a fourth server unit, and a battery manufacturing device, according to another embodiment of this disclosure may comprise a step in which the third server unit classifies alarms by importance level using an analysis information occurred in the second server unit based on a possible alarm information stored in the first server unit; and a step in which the fourth server unit notifies the alarm's classified importance level and a corresponding response method.

In another embodiment, the alarm handling method of the battery manufacturing system may further comprise: a step in which the first server unit stores the possible alarm information received from the battery manufacturing device; a step in which the second server unit generates the analysis information based on the possible alarm information.

In another embodiment, the alarm handling method of the battery manufacturing system may further comprise: a step in which the second server unit transmits the analysis information to the third server unit in response to a signal in API (Application Programming Interface) format.

In another embodiment, the step of classifying the occurred alarm by importance level may include a step of classifying the occurred alarm into one of a false alarm, a minor alarm, or an intermediate alarm.

In another embodiment, the analysis information may include criteria for classifying the alarm's importance level, the user's response method according to the importance level, and information for predicting the occurrence of the intermediate alarm.

In another embodiment, the alarm handling method of the battery manufacturing system may further comprise: a step in which the third server unit transmits an alarm prediction notification to the fourth server unit when an intermediate alarm is predicted.

In another embodiment, the alarm handling method of the battery manufacturing system may further comprise: a step in which the third server unit updates the battery manufacturing device to reduce the ratio of the alarms classified as false alarms among the false alarms, the minor alarms, and the intermediate alarms.

In another embodiment, the alarm handling method of the battery manufacturing system may further comprise: a step in which the third server unit transmits the alarm's classified importance level and a corresponding response method to the fourth server unit.

According to an embodiment of the present disclosure, alarms may be classified by grade based on importance, and optimized responses may be provided to the user for each grade.

According to another embodiment of the present disclosure, by predicting intermediate alarms in advance and notifying the user, prompt action may be enabled.

According to another embodiment of the present disclosure, the ratio of false alarms may be reduced, thereby minimizing delays in the battery manufacturing system operation caused by them.

### BRIEF DESCRIPTION OF THE DRAWINGS

FIG. 1 is a block diagram showing a battery manufacturing system.

FIG. 2 is a block diagram illustrating the second server unit of FIG. 1.

FIG. 3 is a block diagram illustrating the third server unit of FIG. 1.

FIG. 4 is a block diagram illustrating the fourth server unit of FIG. 1.

FIG. 5 is a flowchart illustrating an alarm handling method of the battery manufacturing system.

FIG. 6 is a block diagram illustrating S100 in FIG. 5.

FIG. 7 is a block diagram illustrating S200 of FIG. 5.

FIG. 8 is a block diagram illustrating S300 in FIG. 5.

FIG. 9 is a block diagram illustrating S400 of FIG. 5.

FIG. 10 is a block diagram illustrating S500 in FIG. 5.

### DETAILED DESCRIPTION

Hereinafter, preferred embodiments of the present disclosure will be described in detail with reference to the attached drawings. The configuration of the device and the control method described below are only intended to illustrate embodiments of the present disclosure and are not intended to limit the scope of the present disclosure. Reference numerals used throughout the specification represent identical components.

Meanwhile, the battery assembly according to this disclosure is a concept collectively referring to a battery module, a battery pack, and an energy storage system. The battery module refers to a battery assembly where a plurality of battery cells are grouped together in one or more quantities to protect them from external impacts, heat, vibration, etc., and then housed within a case. The battery pack refers to a battery assembly that ultimately accommodates a predetermined number of such battery modules to achieve the desired voltage or power.

Furthermore, the battery assembly according to this disclosure may also refer to a battery pack with a cell to pack structure, which generates the desired voltage or power by accommodating a predetermined number of battery cells without the battery module.

The battery assembly according to this disclosure may be implemented in various shapes. For example, the battery assembly may be cylindrical, and it can also be designed in a prismatic or pouch form.

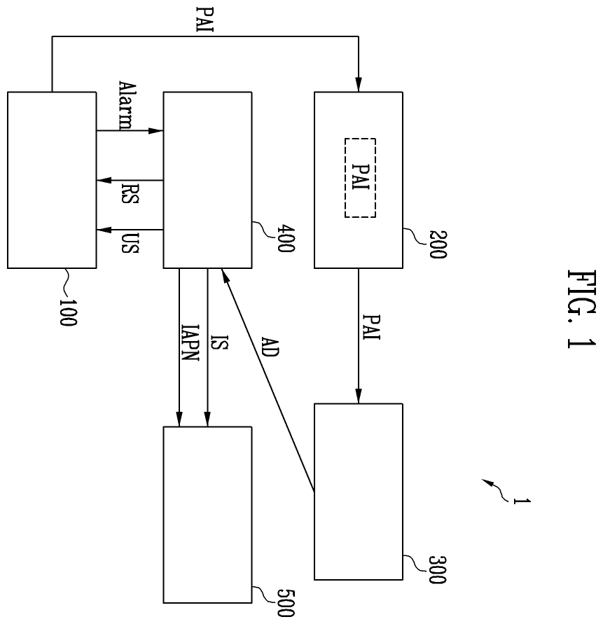

FIG. 1 is a block diagram showing a battery manufacturing system.

Referring to FIG. 1, the battery manufacturing system 1 comprises a battery manufacturing device 100, a first server unit 200 that stores possible alarm information PAI received from the battery manufacturing device 100, a second server unit 300 that generates analysis information AD based on the possible alarm information PAI, and a third server unit 400 that classifies the importance of alarms generated by the battery manufacturing device 100 into grades using the analysis information AD, and a fourth server unit 500 that receives the classified grade of the occurred alarm (Alarm) and the corresponding response from the third server unit 400 and notifies (Notice) the user thereof.

The battery manufacturing device 100 may manufacture a battery cell comprising an electrode assembly with multiple electrodes stacked. The battery manufacturing device 100 may include an electrode manufacturing device, a vision device, and an electrode assembly device.

If an abnormality occurs in the battery manufacturing device 100, an alarm may be activated or may occur. Depending on the type of abnormality that occurs, the alarm type may vary.

Among the abnormalities that occur, some require replacement of components within the battery manufacturing device 100, necessitating relatively more time for resolution. Conversely, other abnormalities do not require component replacement within the battery manufacturing device 100, allowing for resolution in a relatively shorter time. While a skilled user is well-versed in the corrective actions for the battery manufacturing device 100 corresponding to the occurred alarm, an unskilled user may find it difficult to perform the appropriate corrective action for the occurred alarm quickly and reliably. Therefore, if the method for handling the malfunction of the battery manufacturing device 100 corresponding to the occurred alarm could be communicated to the user when the alarm occurs, the corrective action could be performed quickly and reliably.

The first server unit 200 may receive and store possible alarm information PAI that may occur from the battery manufacturing device 100. The possible alarm information PAI may include various information such as occurrence conditions for various alarms generated by the battery manufacturing device 100 and a history of actions taken regarding abnormalities in the battery manufacturing device 100 corresponding to the alarms. Here, the possible alarm information PAI may also include information about alarms that have generated in the battery manufacturing device 100.

According to an embodiment, the amount of PAI stored in the first server unit 200 may gradually increase over time.

The second server unit 300 may receive the possible alarm information PAI from the first server unit 200. The second server unit 300 may generate analysis information AD based on the possible alarm information PAI received from the first server unit 200. More specifically, the second server unit 300 may learn the possible alarm information PAI and generate analysis information AD based on it.

Here, the analysis information AD may include criteria for classifying the grade of an alarm that has occurred, the user's response method or action method according to the grade, and information for predicting the occurrence of an intermediate alarm.

According to the implementation example, as the possible alarm information PAI transmitted to the second server unit 300 is increased, the more specifically the grade of the occurred alarm may be classified. Furthermore, as the possible alarm information PAI transmitted to the second server unit 300 is increased, the more efficiently the user response corresponding to the alarm grade may be optimized. Furthermore, as the PAI transmitted to the second server unit 300 is increased, the information available for predicting alarm occurrences is increased.

The second server unit 300 may transmit analysis information AD to the third server unit 400 in response to signals in API (Application Programming Interface) format.

The third server unit 400 may receive analysis information AD from the second server unit 300. Furthermore, the third server unit 400 is connected to the battery manufacturing device 100 and may receive occurred alarms or information about occurred alarms from the battery manufacturing device 100. The third server unit 400 may classify the importance of the occurred alarm into grades using the analysis information AD.

The importance grade of the occurred alarm may be determined by considering factors such as the time required to address the abnormality in the battery manufacturing device 100 and the methods for addressing the abnormality in the battery manufacturing device 100. For example, the longer the time required to address the abnormality in the battery manufacturing device 100, the higher the importance grade of the occurred alarm may become. For instance, if replacing components is necessary to address the abnormality in the battery manufacturing device 100, the importance of the occurred alarm may increase. Conversely, if replacing components is not required to address the abnormality in the battery manufacturing device 100, the importance of the occurred alarm may decrease.

Alarms generated in the battery manufacturing system 1 according to this disclosure may be classified into false alarms and intermediate alarms. Here, a false alarm refers to a case where the battery manufacturing system 1 or the battery manufacturing device 100 generates an alarm even though no actual abnormality or problem has occurred in the battery manufacturing device 100. This can typically occur due to sensor malfunction, incorrect settings, data errors, or excessive system sensitivity within the battery manufacturing device 100. An intermediate alarm refers to an alarm that may occur in situations requiring relatively long processing times, such as component replacement, to address an abnormality in the battery manufacturing device 100.

In the battery manufacturing system 1 according to this disclosure, occurred alarms may be classified not only as false alarms and intermediate alarms but also as minor alarms. Here, a minor alarm refers to an alarm that can occur in situations requiring relatively short processing time, such as when no component replacement is needed to address an abnormality in the battery manufacturing device 100.

If the third server unit 400 determines that the occurred alarm corresponds to a false alarm, it may transmit a reset signal RS to the battery manufacturing device 100 to eliminate the false alarm. Although a user may manually clear a false alarm generated by the battery manufacturing device 100, having the third server unit 400 handle the false alarm instead enables more rapid action.

In cases where a false alarm occurs in the battery manufacturing device 100 despite no actual abnormality or problem existing, causing the battery manufacturing device 100 to halt operation, losses may occur in battery production, etc. In other words, as the number of false alarms occurring in the battery manufacturing device 100 increases, losses in battery production, etc., may also increase. Therefore, the third server unit 400 may transmit an update signal US to the battery manufacturing device 100 to update it, thereby reducing the ratio of alarms classified as false alarms among false alarms, minor alarms, and intermediate alarms. More specifically, the third server unit 400 may update the battery manufacturing device 100 so that false alarms do not occur under the same circumstances or circumstances where no actual abnormality or problem has occurred in the battery manufacturing device 100.

The third server unit 400 may transmit an information signal IS, an intermediate alarm prediction notification IAPN, etc., to the fourth server unit 500.

The information signal IS may include information generated by the third server unit 400 utilizing the analysis information AD received from the second server unit 300. For example, the information signal IS may include the grade of the alarm that occurred and the corresponding response method.

Similarly, an Intermediate Alarm Prognosis Notification (IAPN) may be a notification that utilizes information necessary for predicting the occurrence of an intermediate alarm included in the analysis information AD to enable prompt action by being transmitted to the fourth server unit 500 when an intermediate alarm is expected to occur in the battery manufacturing device 100.

The fourth server unit 500 may receive the information signal IS and the intermediate alarm prediction notification IAPN from the third server unit 400.

Upon receiving an information signal IS, the fourth server unit 500 may notify the user of the alarm's importance grade and the corresponding response method. The alarm's importance grade and the corresponding response method may be transmitted to the user in various ways, such as through visual or voice alerts.

Similarly, upon receiving the intermediate alarm prediction notification IAPN, the fourth server unit 500 may notify the user of the predicted intermediate alarm occurrence through various means, such as visual or audio alerts.

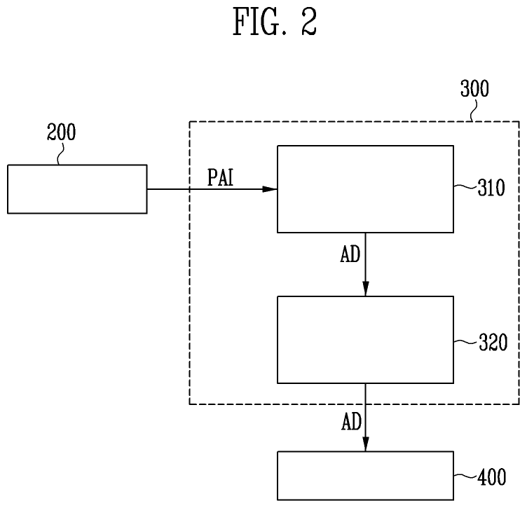

FIG. 2 is a block diagram illustrating the second server unit of FIG. 1.

Referring to FIGS. 1 and 2, the battery manufacturing system 1 may include a first server unit 200, a second server unit 300, and a third server unit 400.

In an embodiment, the second server unit 300 may include an analysis unit 310 generating the analysis information AD based on the possible alarm information PAI and a communication interface 320 transmitting the analysis information AD to the third server unit in response to a signal in API format.

For example, the second server unit 300 may include an analysis unit 310 that generates analysis information AD based on possible alarm information PAI, and a communication interface 320 that transmits the analysis information AD to the third server unit 400 in response to a signal in API format.

The analysis unit 310 may receive possible alarm information PAI from the first server unit 200.

The analysis unit 310 may generate analysis information AD based on the possible alarm information PAI received from the first server unit 200. More specifically, the analysis unit 310 can learn the possible alarm information PAI and generate analysis information AD based on it.

According to the implementation example, as the possible alarm information PAI transmitted to the analysis unit 310 is increased, the more specifically the grade of the occurred alarm may be classified. Furthermore, as the possible alarm information PAI transmitted to the analysis unit 310 is increased, the more efficiently user response measures may be optimized according to the alarm grade. Furthermore, the more abundant the possible alarm information PAI transmitted to the analysis unit 310, the more abundant the information that may be utilized to predict the occurrence of alarms.

Analysis information AD generated by the analysis unit 310 may be transmitted to the communication interface 320. The communication interface 320 may transmit the analysis information AD to the third server unit 400 in response to signals in the form of an API (Application Programming Interface).

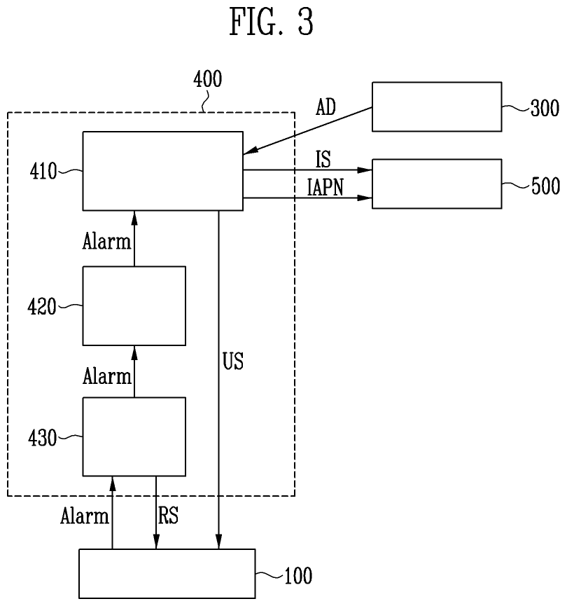

FIG. 3 is a block diagram illustrating the third server unit of FIG. 1.

Referring to FIGS. 1 and 3, the battery manufacturing system 1 may include a second server unit 300, a third server unit 400, and a fourth server unit 500.

In an embodiment, the third server unit 400 may include a false alarm reset engine 430 determining whether the occurred alarm corresponds to the false alarm and automatically resetting the battery manufacturing device 100 when alarm is confirmed as a false alarm, and an alarm analysis engine 410 classifying the importance of alarm generated by the battery manufacturing device 100 into grades using the analysis information AD.

The third server unit 400 may include a false alarm reset engine 430 that determines whether an alarm corresponds to a false alarm and, if confirmed as a false alarm, automatically resets the battery manufacturing device 100, and an alarm analysis engine 410 that utilizes analysis information AD to classify the severity of alarms generated by the battery manufacturing device 100 into graded levels.

The third server unit 400 may further include an alarm log unit 420 that receives alarms generated by the false alarm reset engine 430 and transmits them to the alarm analysis engine 410.

The alarm analysis engine 410 may receive analysis information AD from the second server unit 300. Furthermore, the false alarm reset engine 430 is connected to the battery manufacturing device 100 and may receive an alarm or information about the alarm from the battery manufacturing device 100. The occurred alarm may be transmitted from the false alarm reset engine 430 to the alarm analysis engine 410 via the alarm log unit 420. The alarm analysis engine 410 may classify the importance of the occurred alarm into grades using analysis information AD. More specifically, the alarm analysis engine 410 may classify the occurred alarm as a false alarm, a minor alarm, or an intermediate alarm using the analysis information AD.

Not only the alarm analysis engine 410, but also the false alarm reset engine 430 may determine whether the occurred alarm corresponds to a false alarm. If the alarm corresponds to a false alarm, the false alarm reset engine 430 may transmit a reset signal RS to the battery manufacturing device 100 to eliminate the false alarm. Although a user may manually remove a false alarm generated by the battery manufacturing device 100, the false alarm reset engine 430 enables faster action by handling false alarms on the user's behalf.

In cases where a false alarm occurs in the battery manufacturing device 100 despite no actual abnormality or problem existing, causing the battery manufacturing device 100 to halt operation, losses may occur in battery production, etc. In other words, as the number of false alarms occurring in the battery manufacturing device 100 increases, losses in battery production, etc., may grow larger. Therefore, the alarm analysis engine 410 can send an update signal US to the battery manufacturing device 100 to update the battery manufacturing device 100 in order to reduce the ratio of alarms that are classified as false alarms among false alarms, minor alarms, and intermediate alarms. More specifically, the alarm analysis engine 410 may update the battery manufacturing device 100 so that false alarms do not occur under the same circumstances or, circumstances where no actual abnormality or problem has occurred in the battery manufacturing device 100.

The alarm analysis engine 410 may transmit an information signal IS to the fourth server unit 500. Furthermore, the alarm analysis engine 410 may transmit an intermediate alarm prediction notification IAPN to the fourth server unit 500 when an intermediate alarm is predicted.

The information signal IS may include information generated by the alarm analysis engine 410 utilizing analysis information AD received from the second server unit 300. For example, the information signal IS may include the grade of the alarm that occurred and the corresponding response method.

Similarly, the IAPN may be generated by the alarm analysis engine 410 using information contained within the AD that is necessary for predicting the occurrence of an intermediate alarm. The intermediate alarm prediction notification IAPN may be a notification sent to the fourth server unit 500 when an intermediate alarm is predicted to occur in the battery manufacturing device 100, enabling prompt action.

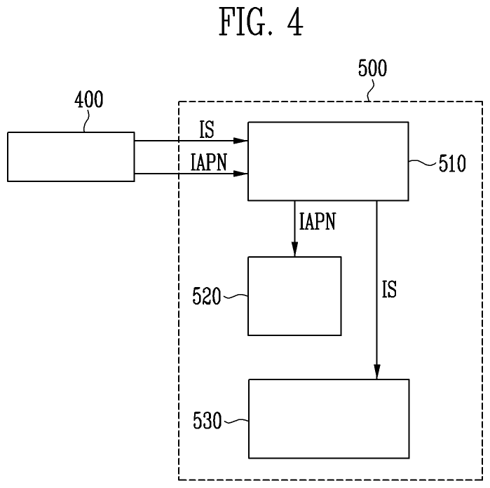

FIG. 4 is a block diagram illustrating the fourth server unit of FIG. 1.

Referring to FIGS. 1 and 4, the battery manufacturing system 1 may include a third server unit 400 and a fourth server unit 500.

The fourth server unit 500 may include a control unit 510, a first display unit 520, and a second display unit 530.

The control unit 510 may perform operations to control the first display unit 520 and the second display unit 530. For example, the control unit 510 may receive an information signal IS and an intermediate alarm prediction notification IAPN from the third server unit 400. The control unit 510 may transmit the information signal IS to the first display unit 520. The control unit 510 may transmit the intermediate alarm prediction notification IAPN to the second display unit 530.

The first display unit 520, upon receiving the intermediate alarm prediction notification IAPN, can notify the user. In other words, the first display unit 520 may notify the user in various ways, such as through visual or audible alerts, that an intermediate alarm is predicted to occur.

Upon receiving the information signal IS, the second display unit 530 may notify the user of the grade of the alarm that has occurred and the corresponding response method. The grade of the alarm that has occurred and the corresponding response method may be notified to the user in various ways through visual or audible alerts.

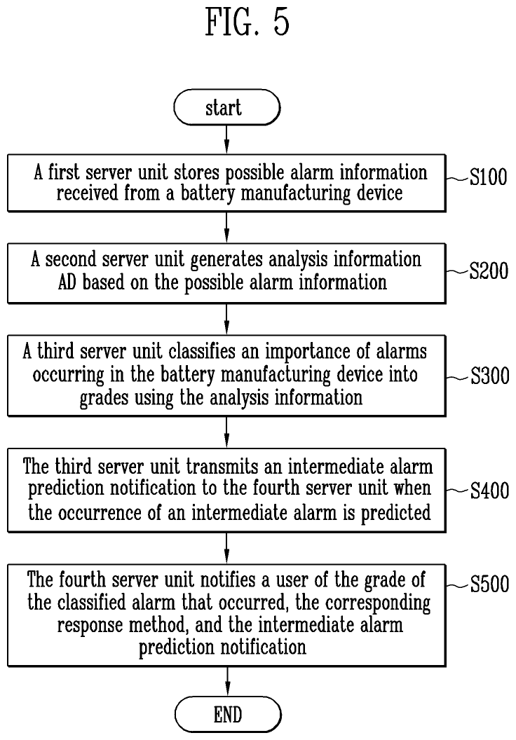

FIG. 5 is a flowchart illustrating an alarm handling method of the battery manufacturing system.

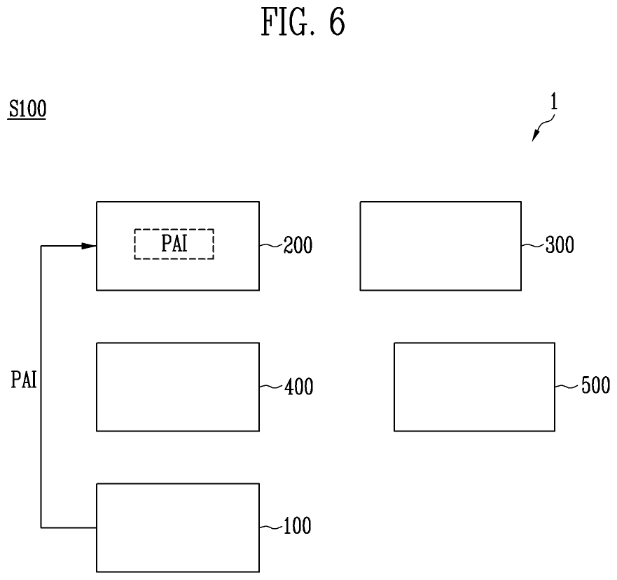

Referring to FIGS. 1 and 5, in step S100, the first server unit 200 may store the possible alarm information PAI received from the battery manufacturing device 100. This is described in detail later with reference to FIG. 6.

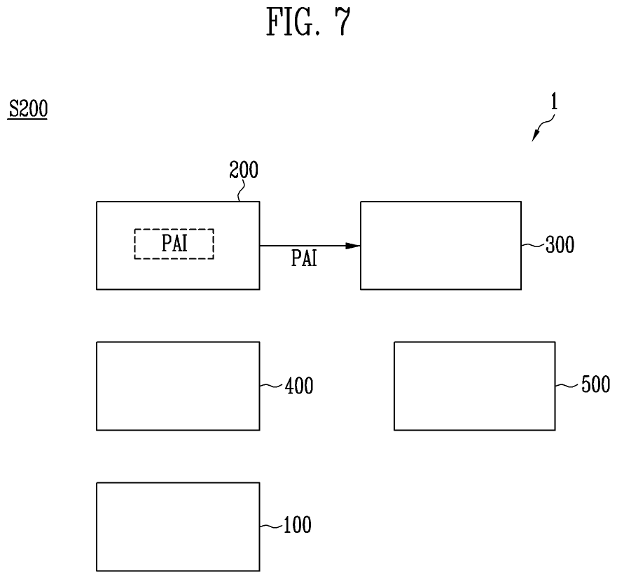

In step S200, the second server unit 300 may generate analysis information AD based on the possible alarm information PAI. This will be described in detail later with reference to FIG. 7.

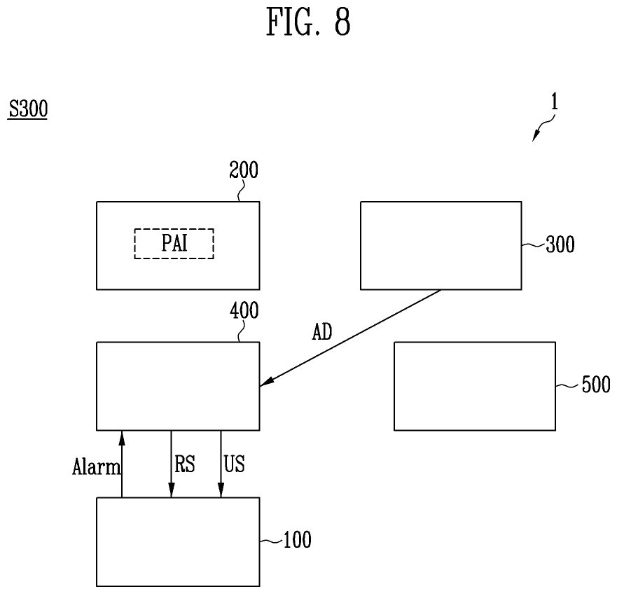

In step S300, the third server unit 400 may classify the importance of alarms occurring in the battery manufacturing device 100 into grades using the analysis information AD generated by the second server unit 300 based on the possible alarm information PAI stored in the first server unit 200. This is described in detail later with reference to FIG. 8.

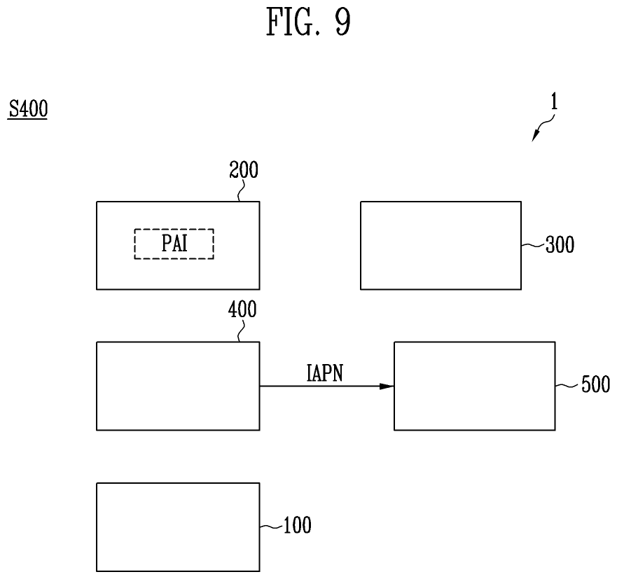

In step S400, the third server unit 400 may transmit an intermediate alarm prediction notification IAPN to the fourth server unit 500 when the occurrence of an intermediate is predicted. This is described in detail later with reference to FIG. 9.

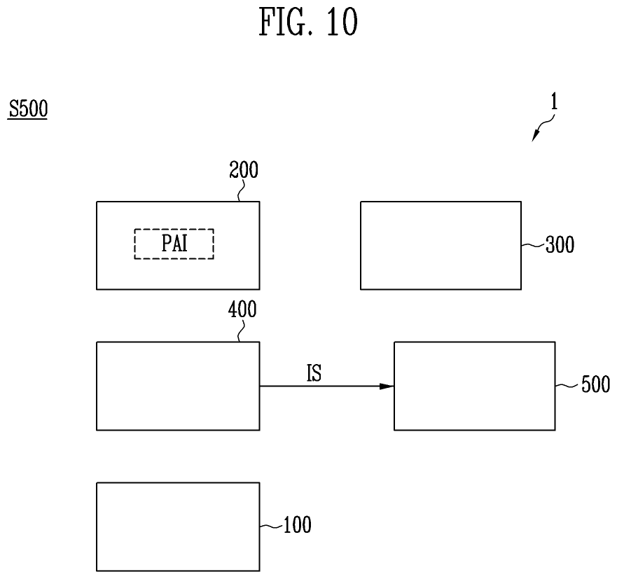

In step S500, the fourth server unit 500 may notify the user of the grade of the classified alarm that occurred, the corresponding response method, and the IAPN. This is described in detail later with reference to FIG. 10.

Steps S100 and S200 may be performed prior to steps S300 through S500, or they may be performed in parallel.

FIG. 6 is a block diagram illustrating S100 in FIG. 5.

Referring to FIGS. 1, 5, and 6, the first server unit 200 may receive and store the possible alarm information PAI that may be generated from the battery manufacturing device 100. The possible alarm information PAI may include various information such as occurrence conditions for various alarms generated in the battery manufacturing device 100 and a history of actions taken in response to abnormalities in the battery manufacturing device 100 corresponding to the alarms. Here, the possible alarm information PAI may also include information about alarms that have occurred in the battery manufacturing device 100.

According to an embodiment, the amount of PAI stored in the first server unit 200 may gradually increase over time.

FIG. 7 is a block diagram illustrating S200 of FIG. 5.

Referring to FIGS. 1, 5, and 7, the second server unit 300 may receive possible alarm information PAI from the first server unit 200. The second server unit 300 may generate analysis information AD based on the possible alarm information PAI received from the first server unit 200. More specifically, the second server unit 300 may learn the possible alarm information PAI and generate analysis information AD based on it.

Here, the analysis information AD may include criteria for classifying the level of an alarm that has occurred, the user's response method or action method according to the aforementioned level, and information for predicting the occurrence of an intermediate alarm.

According to the implementation example, as the possible alarm information PAI transmitted to the second server unit 300 is increased, the more specifically the grade of the occurred alarm may be classified. Furthermore, as the possible alarm information PAI transmitted to the second server unit 300 is increased, the more efficiently the user response plan corresponding to the alarm grade may be optimized. Furthermore, as the PAI transmitted to the second server unit 300 is increased, the information available for predicting the occurrence of alarms is increased.

FIG. 8 is a block diagram illustrating S300 in FIG. 5.

Referring to FIGS. 1, 5, and 8, the second server unit 300 may transmit analysis information AD to the third server unit 400 in response to signals in the form of an API (Application Programming Interface).

The third server unit 400 may receive analysis information AD from the second server unit 300. Furthermore, the third server unit 400 is connected to the battery manufacturing device 100 and may receive alarms or information about alarms that have occurred from the battery manufacturing device 100. Furthermore, the third server unit 400 may classify the importance of the occurred alarm into grades using the analysis information AD.

The importance of an alarm that has occurred may be determined by considering factors such as the time required to address an abnormality in the battery manufacturing device 100 and the method for addressing the abnormality in the battery manufacturing device 100. For example, the longer the time required to address an abnormality in the battery manufacturing device 100, the higher the importance of the alarm that has occurred may be. For instance, if replacing parts is necessary to address an abnormality in the battery manufacturing device 100, the importance of the occurred alarm may increase. Conversely, if replacing parts is not required to address an abnormality in the battery manufacturing device 100, the importance of the occurred alarm may decrease.

Alarms generated in the battery manufacturing system 1 according to this disclosure may be classified as false alarms and intermediate alarms. Here, a false alarm refers to a case where the battery manufacturing system 1 or the battery manufacturing device 100 generates an alarm even though no actual abnormality or problem has occurred in the battery manufacturing device 100. This can typically occur due to sensor malfunction, incorrect settings, data errors, or excessive system sensitivity within the battery manufacturing device 100. An intermediate alarm refers to an alarm that may occur in situations requiring relatively long processing times, such as component replacement, to address an abnormality in the battery manufacturing device 100.

Here, a minor alarm refers to an alarm that occurs when there is a risk of a shortage of materials required for battery manufacturing, even though no actual abnormality or problem has occurred in the battery manufacturing device 100.

The third server unit 400 may transmit a reset signal RS to the battery manufacturing device 100 to eliminate a false alarm if the occurred alarm corresponds to a false alarm. Although a user can manually remove a false alarm occurring in the battery manufacturing device 100, having the third server unit 400 handle the false alarm instead enables more rapid action.

In cases where a false alarm occurs in the battery manufacturing device 100 despite no actual abnormality or problem existing, requiring the device 100 to halt operation, losses may occur in battery production and other processes. In other words, as the ratio of false alarms in the battery manufacturing device 100 increases, losses in battery production and other processes may grow larger. Therefore, the third server unit 400 may transmit an update signal US to the battery manufacturing device 100 to update the battery manufacturing device 100, thereby reducing the ratio of alarms that are classified as false alarms among false alarms, minor alarms, and intermediate alarms. More specifically, the third server unit 400 can update the battery manufacturing device 100 so that false alarms do not occur in the same situation or, a situation where no actual abnormality or problem has occurred in the battery manufacturing device 100.

FIG. 9 is a block diagram illustrating S400 of FIG. 5.

Referring to FIGS. 1, 5, and 9, the third server unit 400 may transmit an intermediate alarm prediction notification IAPN to the fourth server unit 500 when the occurrence of an intermediate alarm is predicted.

The intermediate alarm prediction notification IAPN may be a notification sent from the battery manufacturing device 100 to the fourth server unit 500 when an intermediate alarm is predicted to occur, utilizing information necessary for predicting intermediate alarm occurrence included in the analysis information AD, thereby enabling prompt action.

FIG. 10 is a block diagram illustrating S500 in FIG. 5.

Referring to FIGS. 1, 5, and 10, the third server unit 400 may transmit an information signal IS to the fourth server unit 500, which includes the grade of the alarm that occurred and the corresponding response method. The fourth server unit 500 may receive the information signal IS and the intermediate alarm prediction notification IAPN from the third server unit 400.

Upon receiving the information signal IS, the fourth server unit 500 may notify the user of the alarm grade and the corresponding response method. The alarm grade and response method may be communicated to the user in various ways, such as through visual or voice alerts.

Similarly, upon receiving an IAPN, the fourth server unit 500 may notify the user in various ways, such as through visual or audio alerts, that an intermediate alarm is predicted to occur.

In the alarm handling method for the battery manufacturing system according to this disclosure, by informing the user when an alarm occurs, the method for handling the abnormality of the battery manufacturing device 100 corresponding to the occurred alarm enables swift and stable corrective action.

What is claimed is:

1. A battery manufacturing system, comprising:
a first server unit configured to store a possible alarm information received from a battery manufacturing device;
a second server unit configured to generate an analysis information based on the possible alarm information;
a third server unit configured to classify alarms by importance level using the analysis information; and
a fourth server unit configured to receive the alarm's classified importance level and a corresponding response method from the third server unit and to notify a user thereof.

2. The battery manufacturing system according to claim 1, wherein the second server unit transmits the analysis information to the third server unit in response to a signal in API (Application Programming Interface) format.

3. The battery manufacturing system according to claim 2, wherein the second server unit includes an analysis unit generating the analysis information based on the possible alarm information and a communication interface transmitting the analysis information to the third server unit in response to a signal in API format.

4. The battery manufacturing system according to claim 1, wherein the third server unit classifies an occurred alarm into a false alarm and an intermediate alarm.

5. The battery manufacturing system according to claim 4, wherein the third server unit classifies the occurred alarm as one of a false alarm, an intermediate alarm, or a minor alarm.

6. The battery manufacturing system according to claim 5, wherein the analysis information includes criteria for classifying the alarm's importance level.

7. The battery manufacturing system according to claim 5, wherein the third server unit includes:
a false alarm reset engine determining whether the occurred alarm corresponds to the false alarm and automatically resetting the battery manufacturing device when alarm is confirmed as a false alarm; and
an alarm analysis engine that classifies alarms by importance level using the analysis information.

8. The battery manufacturing system according to claim 7, wherein the alarm analysis engine transmits an alarm prediction notification to the fourth server unit when an intermediate alarm is predicted.

9. The battery manufacturing system according to claim 7, wherein the alarm analysis engine updates the battery manufacturing device to reduce the ratio of the alarms classified as false alarms among the false alarms, the minor alarms, and the intermediate alarms.

10. The battery manufacturing system according to claim 7, wherein the alarm analysis engine transmits the alarm's classified importance level and a corresponding response method to the fourth server unit.

11. The battery manufacturing system according to claim 7, wherein the false alarm reset engine is connected to the battery manufacturing device and receives alarms that occur from the battery manufacturing device.

12. The battery manufacturing system according to claim 7, wherein the third server unit further includes an alarm log unit receiving the occurred alarm from the false alarm reset engine and transmitting it to the alarm analysis engine.

13. An alarm handling method of a battery manufacturing system, including a first server unit, a second server unit, a third server unit, a fourth server unit, and a battery manufacturing device, comprising:
a step in which the third server unit classifies alarms by importance level using an analysis information occurred in the second server unit based on a possible alarm information stored in the first server unit; and
a step in which the fourth server unit notifies the alarm's classified importance level and a corresponding response method.

14. The alarm handling method of the battery manufacturing system according to claim 13, further comprising:
a step in which the first server unit stores the possible alarm information received from the battery manufacturing device;
a step in which the second server unit generates the analysis information based on the possible alarm information.

15. The alarm handling method of the battery manufacturing system according to claim 14, further comprising:
a step in which the second server unit transmits the analysis information to the third server unit in response to a signal in API (Application Programming Interface) format.

16. The alarm handling method of the battery manufacturing system according to claim 14, wherein the step of classifying the occurred alarm by importance level includes a step of classifying the occurred alarm into one of a false alarm, a minor alarm, or an intermediate alarm.

17. The alarm handling method of the battery manufacturing system according to claim 16, wherein the analysis information includes criteria for classifying the alarm's importance level, the user's response method according to the importance level, and information for predicting the occurrence of the intermediate alarm.

18. The alarm handling method of the battery manufacturing system according to claim 16, further comprising:
a step in which the third server unit transmits an alarm prediction notification to the fourth server unit when an intermediate alarm is predicted.

19. The alarm handling method of the battery manufacturing system according to claim 16, further comprising:
a step in which the third server unit updates the battery manufacturing device to reduce the ratio of the alarms classified as false alarms among the false alarms, the minor alarms, and the intermediate alarms.

20. The alarm handling method of the battery manufacturing system according to claim 16, further comprising:
a step in which the third server unit transmits the alarm's classified importance level and a corresponding response method to the fourth server unit.
